(19) United States
(12) Patent Application Publication
(10) Pub. No.: US 2006/0055499 A1
(43) Pub. Date: Mar. 16, 2006

(54) Fuse arrangement

(76) Inventor: Cristian A. Bolle, Bridgewater, NJ (US)

Correspondence Address: Lucent Technologies Inc.;Docket Administrator - Room 3J-219, 101 Crawfords Corner Road, Holmdel, NJ, 07733-3030, US

(21) Appl. No.: 10/942,553

(22) Filed: Sep. 16, 2004

(51) Int. Cl. H01H 85/02

(52) U.S. Cl. 337/157

(57) ABSTRACT

A highly reliable fuse can be achieved by employing a micro mechanical device that operates to entirely disconnect a relatively low impedance circuit coupled to a pair of electrical connection points, e.g., circuit points or terminals. The removal of the electrical circuit is performed as a result of the movement of the micro mechanical device. More specifically, the electrical connection may be removed by having at least one low impedance electrical bridge that is part of the circuit break when the micro mechanical device is subjected to prescribed trigger activation forces. When there is more than one relatively low impedance circuit coupling the pair of electrical connection points, all of the relatively low impedance circuits must be disrupted, e.g., by breaking at least one low impedance electrical bridge that is part of each circuit.

### TECHNICAL FIELD

This invention relates to the art of fuses, and more particularly, to one-time fuses that can not be reset.

### BACKGROUND INFORMATION

It is desired that in certain applications that two or more connected points in an electrical connection become disconnected, i.e., “open” under certain prescribed conditions. This opening function is performed by what is commonly called a fuse. Many people are familiar with common fuses that burn up when subjected to the condition of a higher current than their rated capacity, such as may occur in the case of a short circuit, thereby, hopefully, preventing a dangerous condition from causing actual damage, e.g., starting a fire.

For other applications, the prescribed conditions may be large accelerations or shock, such as occurs when an object undergoes an impact. Preferably, such a fuse is designed so that it can distinguish between normal handling conditions and an actual triggering event. In addition it is desirable that the fuse can't be reset in any way after an event, and that the state of the fuse can be easily monitored.

A typical application for such a fuse would be a missile or bomb, that has to explode only when specified conditions are met, such as upon reaching their targets. Otherwise, it is desired that such missiles and bombs can be handled safely. Thus, it is necessary for a missile or bomb to contain a fuse that can differentiate between motions resulting from normal handling, or even severe accidental drops, and between the motions that indicate a need to set off an explosion, e.g., launch or impact. In addition, it is desirable that the operational readiness, as well as the state of the fuse, be testable with the result being perceivable by a human being.

In my prior U.S. patent application Ser. No. 10/817,986, which is incorporated by reference as if fully set forth herein, I recognized that a highly reliable fuse for explosives and armaments can be achieved by employing a micro mechanical device that operates to disrupt a relatively low impedance bypass circuit coupled in parallel with a relatively high impedance trigger mechanism. The removal of the electrical bypassing is performed as a result of the movement of the micro mechanical device to enable detonation under prescribed conditions. The electrical bypassing is removed by having at least one low impedance electrical bridge that is part of the bypass circuit break when the micro mechanical device is subjected to prescribed trigger activation forces, which are typically large forces, such as are generated during launch or impact. However, until the high impedance trigger is destroyed, e.g., as part of the explosive process, the points connected by the low impedance bypass circuit remain connected via the high impedance trigger.

### SUMMARY OF THE INVENTION

I have recognized that a highly reliable fuse can be achieved, in accordance with the principles of the invention, by employing a micro mechanical device that operates to entirely disconnect a pair of electrical connection points, e.g., circuit points or terminals that are connected by a relatively low impedance circuit. This disruption of the low impedance circuit is then detected and responded to by other circuitry or devices coupled to at least one of the connection points.

The removal of the electrical circuit is performed as a result of the movement of the micro mechanical device due to forces on the object of which it is a part. In accordance with an aspect of the invention, the electrical connection is removed by having at least one low impedance electrical bridge that is part of the circuit break when the micro mechanical device is subjected to prescribed trigger activation forces. When there is more than one relatively low impedance circuit coupling the pair of electrical connection points, all of the relatively low impedance circuits must be disrupted, e.g., by breaking at least one low impedance electrical bridge that is part of each circuit.

In one embodiment of the invention, the micro mechanical device is a micro-electrical mechanical system (MEMS) device and the bridge is at least one spring that is part of the MEMS device and also part of the electrical circuit. Breaking the at least one spring disrupts the relatively low impedance circuit, opening the electrical connection between a pair of electrical terminals. In another embodiment of the invention, the bridge is a separate element from the MEMS device and motion of the MEMS device due to the trigger activation forces cause the MEMS device to move such that it breaks the bridge disrupting the relatively low impedance circuit, opening the electrical connection between the connection points.

After moving so as to disrupt the relatively low impedance circuit, the MEMS device may be latched into its new position to prevent it from moving around further.

Motion of multiple MEMS devices may be required to fully open the relatively low impedance circuit, which may be implemented as multiple parallel connections. Advantageously, the redundancy provided by employing multiple MEMS devices, and/or multiple bypass connections, results in greater system safety as well as the ability to design for various types of triggering condition. For example, if two MEMS devices are employed, each coupled via a separate connection between the connection points through respective low-impedance springs, the open circuit will not occur unless both springs are broken. For a redundancy application, the MEMS devices can be arranged such that both must move in the same direction in order to break both springs and thereby cause the open circuit. For specification of the triggering condition, it may be that the MEMS devices must each move in a particular direction in a sequence in order to cause their respective springs to break and thereby activate the open circuit. For example, one spring is arranged to break on lauch of a rocket, which would cause the first MEMS device to effectively move in a first direction with respect to local coordinates, and the second spring is arranged to break on impact of the rocket, which would cause the second MEMS device to effectively move in a direction opposite of the first direction with respect to the same local coordinates. Of course, various combinations can be implemented at the discretion of the implementer. Alternatively, a single MEMS device can be arranged to disrupt the electrical circuit by more than one motion, or to require at least two motions of the MEMS device.

In accordance with another aspect of the invention, the fuse may be arranged so that various ones of its parts may be tested and an indication of the results that is perceivable by a human being provided. Furthermore, the fuse may be arranged to be tested both electrically as well as mechanically. For example, a test voltage may be applied, and the resistance across the fuse is measured to verify the integrity of the relatively low impedance electric circuit. A non zero current indicates that the electric circuit is intact, while zero currents indicate that the fuse has opened, e.g., prematurely. Electrodes may be positioned with respect to the MEMS device, and various voltages supplied to move the MEMS device. The change in capacitance, if any, that results from such movement may be measured, and from the measurement information about the mechanical condition of the MEMS device may be determined.

### BRIEF DESCRIPTION OF THE DRAWING

In the drawing:

FIG. 1 shows an exemplary embodiment of the invention in which the micro mechanical device is a micro-electrical mechanical system (MEMS) device and the bridge is at least one spring that is part of the MEMS device and also part of the electrical circuit;

FIG. 2 shows another exemplary embodiment of the invention, similar to that shown in FIG. 1, but in which there are two bridges that are connected in parallel, each of which is coupled to a MEMS device;

FIG. 3 shows another exemplary embodiment of the invention, similar to that shown in FIG. 1, but in which mass 103 is arranged to be latched in place after moving such that it broke at least one of the bridges;

FIG. 4 shows another exemplary embodiment of the invention, similar to that shown in FIG. 2, but in which the two masses are arranged to be latched in place after moving and breaking at least one of their respective associated ones of the bridges in the same manner as shown in FIG. 3;

FIG. 5 shows another exemplary embodiment of the invention, similar to that shown in FIG. 1, but in which there are springs coupling the mass to posts that are attached to the substrate on which the electrodes sits;

FIG. 6 shows another exemplary embodiment of the invention, similar to that shown in FIG. 5, but also including the locking mechanism of FIG. 3;

FIG. 7 shows another exemplary embodiment of the invention, similar to that shown in FIG. 6, but also including an additional locking mechanism;

FIG. 8 shows another exemplary embodiment of the invention in which the mass is not connected to the bridges;

FIG. 9 shows another exemplary embodiment of the invention that is similar to the embodiment of the invention shown in FIG. 8 but in which accelerations in two opposite directions are required before the electrical connection between the electrical terminals is disrupted;

FIG. 10 shows an exemplary circuit representation of a fuse; and

FIG. 11 shows an application of the fuse of FIG. 10 to control the state of indicator light emitting diode (LED).

### DETAILED DESCRIPTION

The following merely illustrates the principles of the invention. It will thus be appreciated that those skilled in the art will be able to devise various arrangements that, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the invention.

In the claims hereof any element expressed as a means for performing a specified function is intended to encompass any way of performing that function. This may include, for example, a) a combination of electrical or mechanical elements which performs that function or b) software in any form, including, therefore, firmware, microcode or the like, combined with appropriate circuitry for executing that software to perform the function, as well as mechanical elements coupled to software controlled circuitry, if any. The invention as defined by such claims resides in the fact that the functionalities provided by the various recited means are combined and brought together in the manner which the claims call for. Applicant thus regards any means which can provide those functionalities as equivalent as those shown herein.

Unless otherwise explicitly specified herein, the drawings are not drawn to scale.

The term micro-electromechanical systems (MEMS) device as used herein is intended to mean an entire MEMS device or any portion thereof. Thus, if a portion of a MEMS device is inoperative, or if a portion of a MEMS device is occluded, such a MEMS device is nonetheless considered to be a MEMS device for purposes of the present disclosure.

In the description, identically numbered components within different ones of the FIGS. refer to the same components.

A highly reliable fuse can be achieved, in accordance with the principles of the invention, by employing a micro mechanical device that operates to entirely disconnect a pair of electrical connection points, e.g., circuit points or terminals that are connected by a relatively low impedance circuit. This disruption of the low impedance circuit is then detected and responded to by other circuitry or devices coupled to at least one of the connection points.

The removal of the electrical circuit is performed as a result of the movement of the micro mechanical device due to forces on the object of which it is a part. In accordance with an aspect of the invention, the electrical connection is removed by having at least one low impedance electrical bridge that is part of the circuit break when the micro mechanical device is subjected to prescribed trigger activation forces. When there is more than one relatively low impedance circuit coupling the pair of electrical connection points, all of the relatively low impedance circuits must be disrupted, e.g., by breaking at least one low impedance electrical bridge that is part of each relatively low impedance circuit.

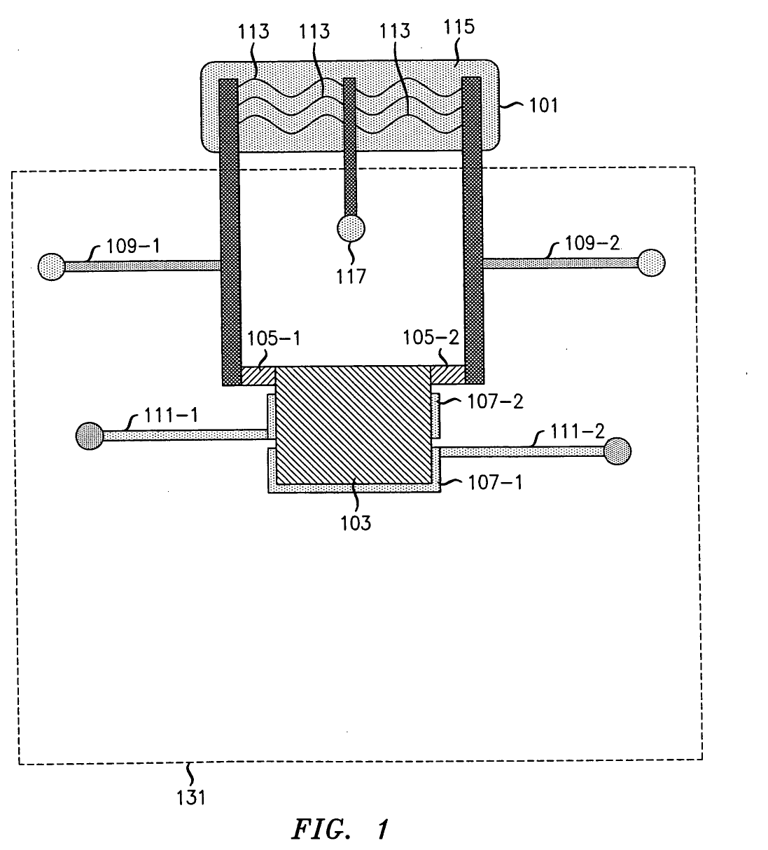

FIG. 1 shows an exemplary embodiment of the invention in which the micro mechanical device is a micro-electrical mechanical system (MEMS) device and the bridge is at least one spring that is part of the MEMS device and also part of the electrical circuit. Breaking the at least one spring disrupts the electrical circuit. More specifically, shown in FIG. 1 are a) a MEMS device including mass 103 and optional electrodes 107, b) bridges 105-1 and 105-2, collectively herein bridges 105; c) electrical connection points 109; d) optional electrical connections 111-1 and 111-2, collectively herein electrical connections 111; and e) optional test ports 113.

Mass 103 is coupled to bridges 105. MEMS device operates by the movement of mass 103 under prescribed conditions so as to exert sufficient force on bridges 105 so that at least one of them breaks. In one embodiment of the invention bridges 105 support mass 103. In another embodiment of the invention mass 103 may be supported at least in part independently of bridges 105.

In accordance with an aspect of the invention, bridges 105 are part of a relatively low impedance electrical circuit that is electrically connected to electrical connection points 109. Thus, so long as bridges 105 remain intact, electrical connection points 109 remain at substantially the same electrical potential.

Optional electrodes 107 may be employed to test the ability of mass 103 to move. By applying a test signal between one of test ports 113 and one of electrical connections 111, mass 103 may be caused to move. The motion of mass 103 may be detected by changes in the capacitance measured between the other of test ports 113 and the other of electrical connections 111. If the capacitance does not change, this indicates that mass 103 has not moved, and the trigger is defective.

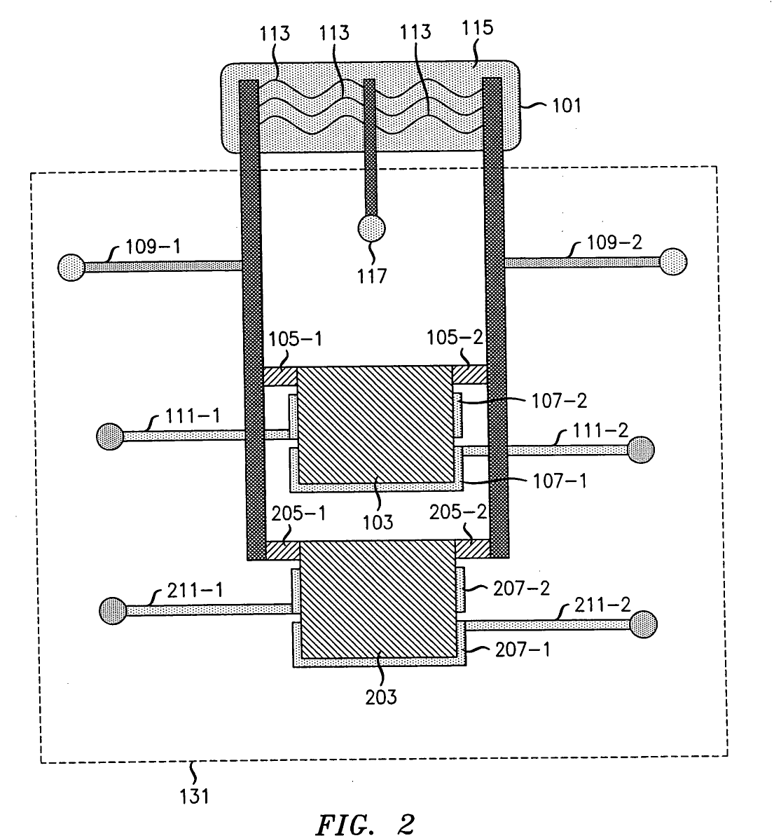

FIG. 2 shows another exemplary embodiment of the invention, similar to that shown in FIG. 1, but in which there are two bridges that are connected in parallel, each of which is coupled to a MEMS device. Only by breaking at least one spring in each of the bridges is the electrical circuit disrupted. FIG. 2 shows all the same elements as FIG. 1 but also includes a) a MEMS device including mass 203 and optional electrodes 207, b) bridges 205-1 and 205-2, collectively herein bridges 205; and c) optional electrical connections 211-1 and 211-2, collectively herein electrical connections 211. Operation of the additional elements of FIG. 2 are the same as their like-named and similarly numbered, except for the leading digit which indicates the FIG. of introduction, counterparts of FIG. 1. Advantageously, the embodiment of the invention of FIG. 2 provides a redundant safety mechanism not present in FIG. 1.

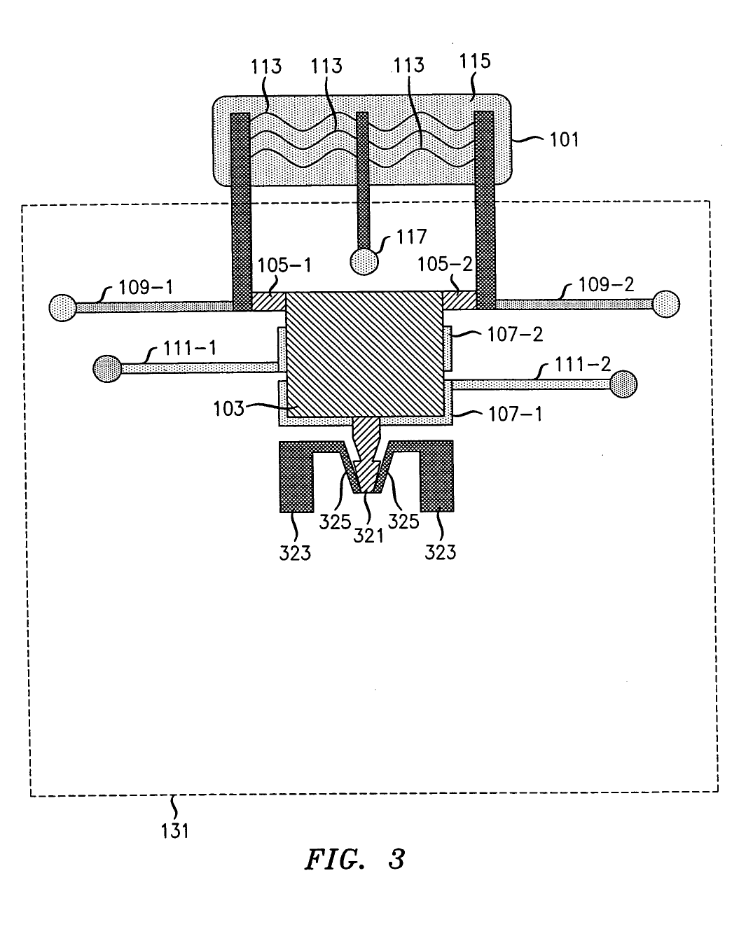

FIG. 3 shows another exemplary embodiment of the invention, similar to that shown in FIG. 1, but in which mass 103 is arranged to be latched in place after moving such that it broke at least one of bridges 105. FIG. 3 shows all the same elements as does FIG. 1, but it also includes a) lockable tab 321 and b) lock receptacle 323. Lockable tab 321 is coupled to mass 103 and moves with mass 103 such that when mass 103 moves toward lock receptacle 323, tab 321 is inserted therein, forcing apart locking arms 325 of lock receptacle 323. Once at least a section of the widest part of tab 321 moves past locking arms 325, locking arms 325 are able to close again, prevent tab 321 from moving back out, and thereby locking in place mass 103. Advantageously, after the breaking of at least one of bridges 105, mass 103 is not permitted to move around freely, which may cause unwanted damage.

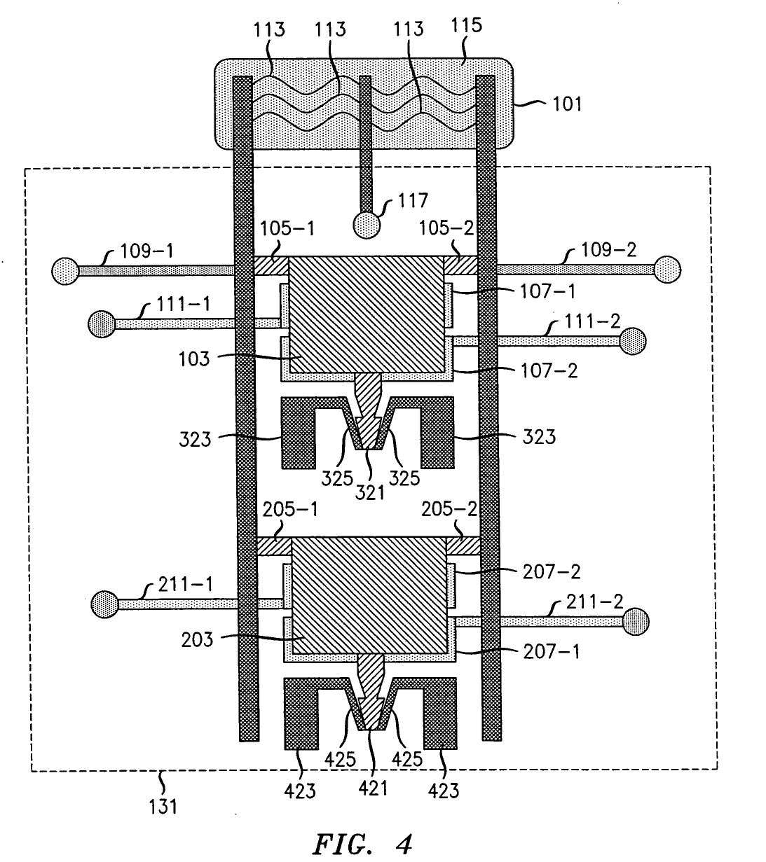

FIG. 4 shows another exemplary embodiment of the invention, similar to that shown in FIG. 2, but in which both masses 103 and 203 are arranged to be latched in place after moving and breaking at least one of their respective associated ones of bridges 105 and 205 in the same manner as shown in FIG. 3. FIG. 4 shows all the same elements as FIG. 2 but also includes a) lockable tab 321 b) and lock receptacle 323, c) lockable tab 421 d) and lock receptacle 423. As described in connection with FIG. 3, lockable tab 321 is coupled to mass 103 and moves with mass 103 such that when mass 103 moves toward lock receptacle 323, tab 321 is inserted therein, forcing apart locking arms 325 of lock receptacle 323. Once at least a section of the widest part of tab 321 moves past locking arms 325, locking arms 325 are able to close again, prevent tab 321 from moving back out, and thereby locking in place mass 103. Advantageously, after the breaking of at least one of bridges 105, mass 103 is not permitted to move around freely, which may cause unwanted damage. Similarly, lockable tab 421 is coupled to mass 203 and moves with mass 203 such that when mass 203 moves toward lock receptacle 423, tab 421 is inserted therein, forcing apart locking arms 425 of lock receptacle 423. Once at least a section of the widest part of tab 421 moves past locking arms 425, locking arms 425 are able to close again, prevent tab 421 from moving back out, and thereby locking in place mass 203. Advantageously, after the breaking of at least one of bridges 105 or 205, mass 103 or mass 203 are not permitted to move around freely, which may cause unwanted damage.

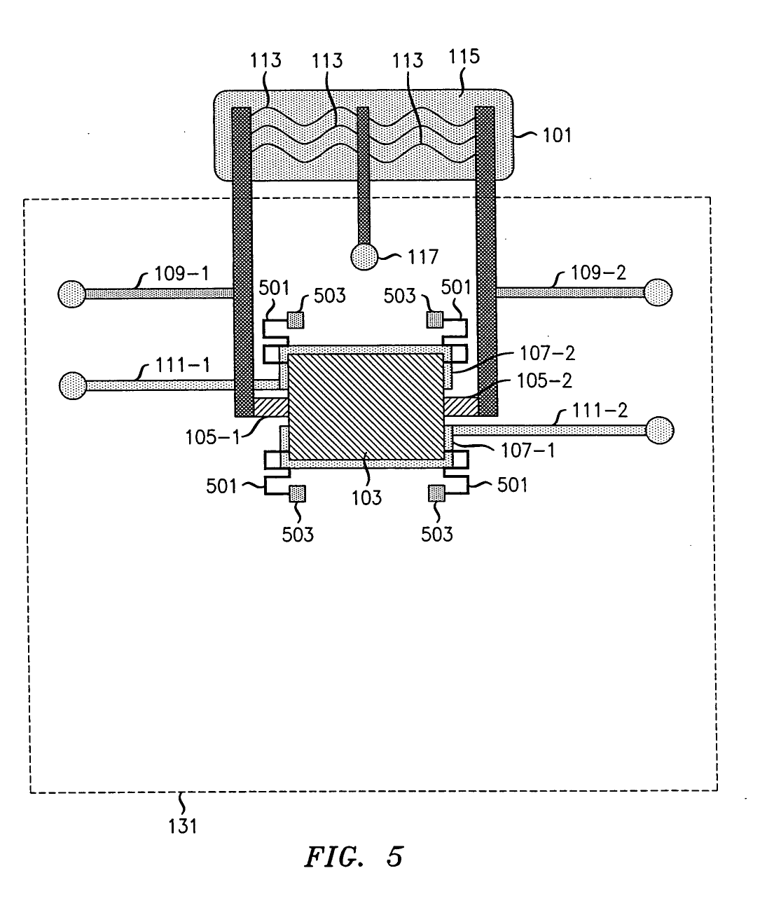

FIG. 5 shows another exemplary embodiment of the invention, similar to that shown in FIG. 1, but in which there are springs 501 coupling mass 103 to posts that are attached to the substrate on which sit electrodes 107. Springs 501 prevent mass 103 from move around freely, which may cause unwanted damage, after the breaking of at least one of bridges 105.

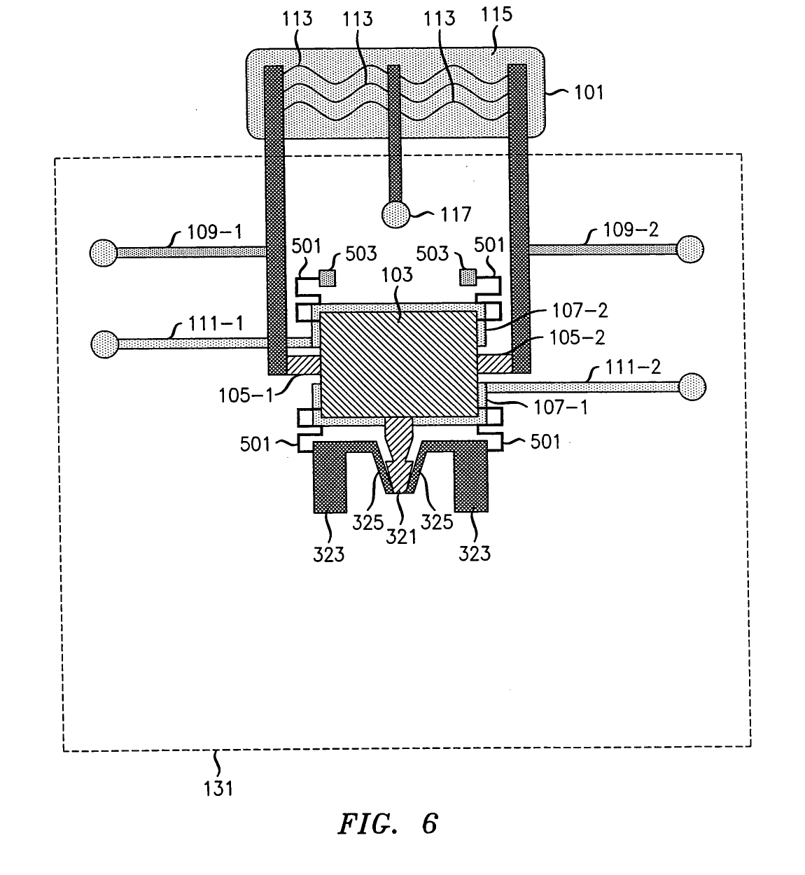

FIG. 6 shows another exemplary embodiment of the invention, similar to that shown in FIG. 5, but also including the locking mechanism of FIG. 3. Not only do springs 501 prevent mass 103 from moving around freely, but, as in FIG. 3, mass 103 is also locked in place by the insertion of tab 321 into lock receptacle 323.

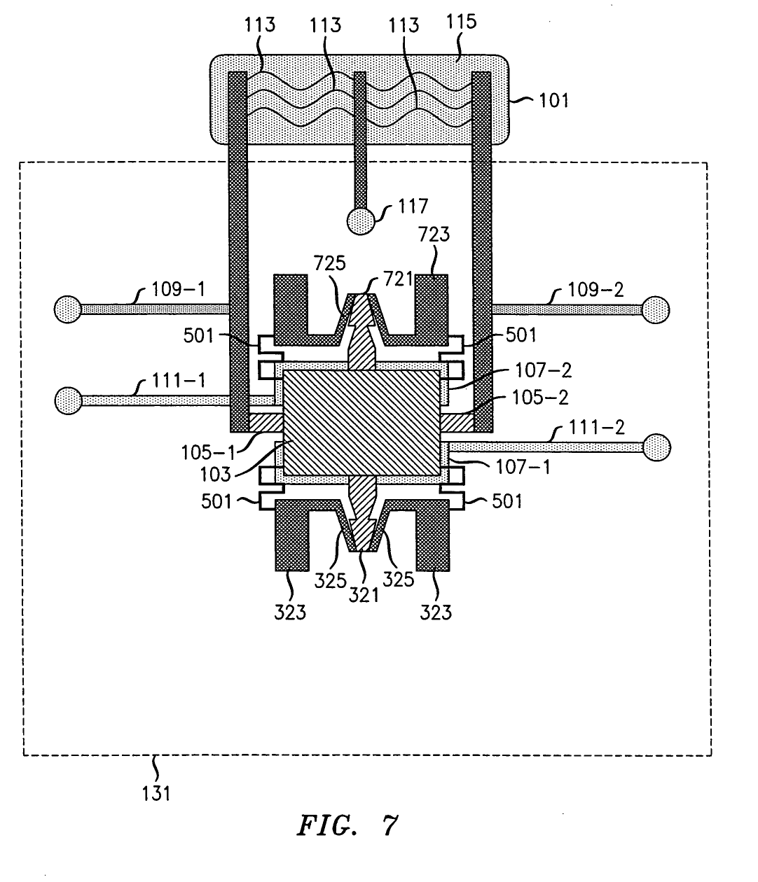

FIG. 7 shows another exemplary embodiment of the invention, similar to that shown in FIG. 6, but also including an additional locking mechanism made up of lockable tab 721 and lock receptacle 723,which includes locking arms 725. Again, as in FIG. 6, not only do springs 501 prevent mass 103 from moving around freely, mass 103 is also locked in place by the insertion of tab 321 into lock receptacle 323, when it moves toward lock receptacle 323. Additionally, should mass 103 move toward lock receptacle 723, it is locked therein by locking arms 725 grabbing lockable tab 721. Thus, the embodiment of FIG. 7 is suitable to be operated with acceleration in any one of two directions.

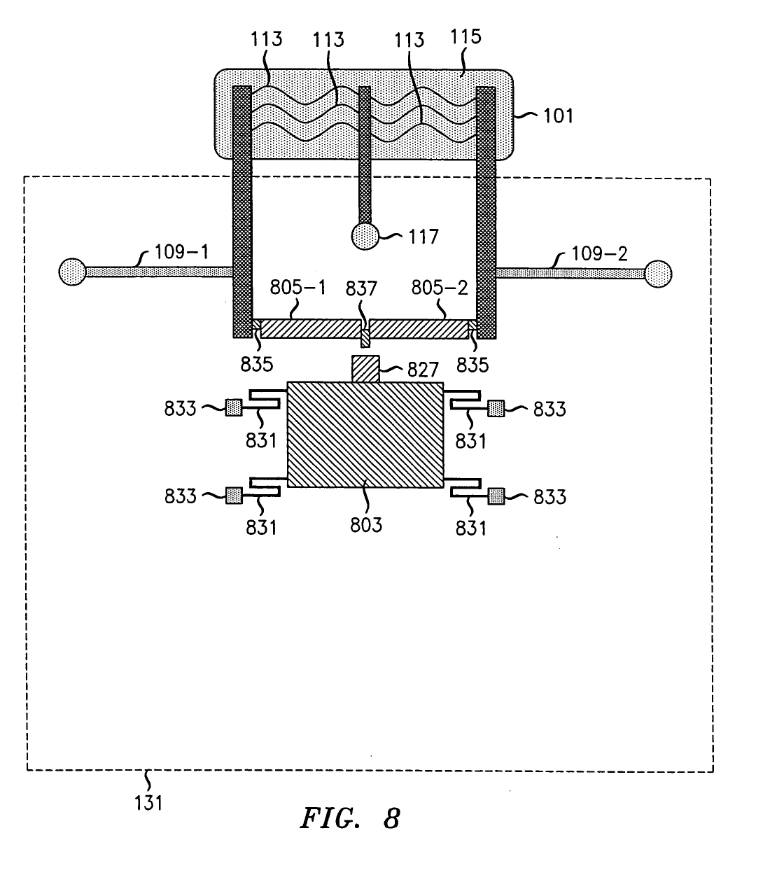

FIG. 8 shows another exemplary embodiment of the invention in which the mass is not connected to the bridges, as in FIG. 1. Instead, sufficient movement of mass 803 toward relatively low impedance electrical connection 801 causes head 827 to strike target point 837 so as to destroy the low impedance connection between electrical connection points 109 by disconnecting bridge 801 from the circuit at at least one of a) weak points 835 or b) target point 837. Mass 803 is coupled via springs 831, which are similar to springs 501, to posts 833. Springs 831 are such that under prescribed acceleration conditions, mass 827 can move to strike target point 832, thereby disrupting the low impedance circuit.

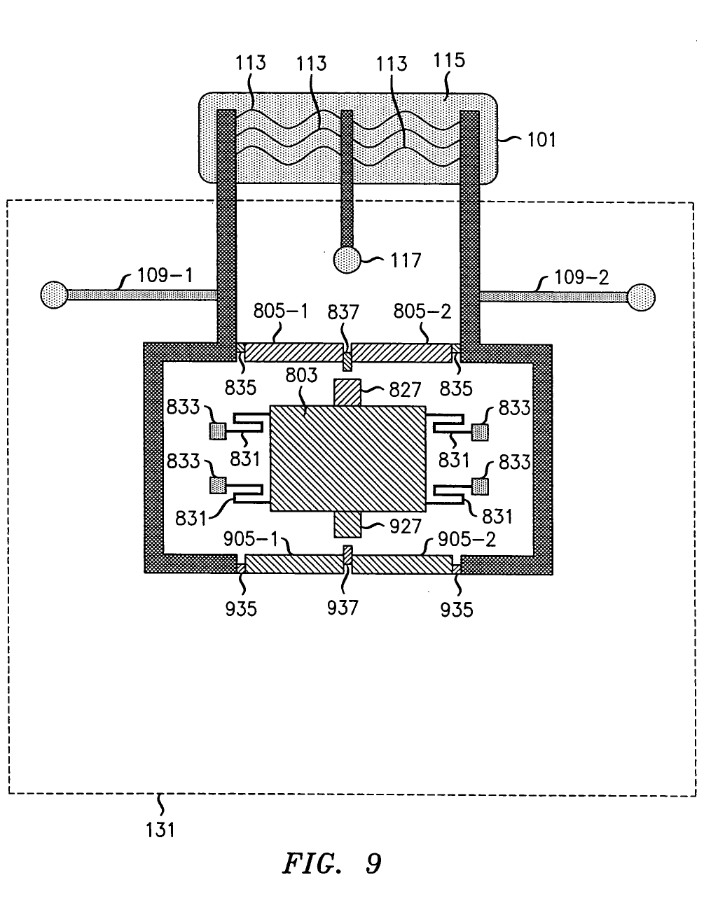

FIG. 9 shows another exemplary embodiment of the invention that is similar to the embodiment of the invention shown in FIG. 8 but in which acceleration toward relatively low impedance electrical connection 801 and away from relatively low impedance electrical connection 801 is required before the relatively low impedance electrical connection between electrical ports 109-1 is disrupted. Regarding acceleration toward relatively low impedance electrical connection 801, the embodiment of FIG. 9 operates as does that of FIG. 8. In addition, movement of mass 803 away from relatively low impedance electrical connection 801 causes head 927 to strike target point 937 so as to destroy the additional branch of the low impedance connection between electrical connections 109-1 by disconnecting at least one of bridges 901 at at least one of weak points 935 or target point 937 from the circuit. Only when both branches of the low impedance connection between electrical connections 109-1 are destroyed does the fuse change to an open state.

FIG. 10 shows an exemplary circuit representation of a fuse. In the manner shown, voltage supply 1001 is connected at a first connection point to relatively high impedance resistor 1003. This resistor is in turn connected to fuse 1005, implemented in accordance with the principles of the invention and represented in FIG. 10 by a black box that is connected to ground 1009 at its second connection point. Output terminal 1007 is connected to the point where resistor 1003 and fuse 1005 are electrically connected. While fuse 1003 is intact, the output voltage at terminal 1007 will be close to zero. Once fuse 1003 changes to an open state, e.g., upon the breaking of one of two bridges therein, the connection to ground will become disconnection. Consequently, the output voltage at terminal 107 will swing from ground to the supplied voltage 1001.

FIG. 11 shows an application of the fuse of FIG. 10 to control the state of indicator light emitting diode (LED) 1011. As shown in FIG. 11, terminal 1007 is connected to gate 1113 of field effect transistor (FET) 1115. While fuse 1005 is intact, gate 1113 of FET 1115 will be at ground voltage, and FET 1115 will not conduct between its drain 1117 and its source 1119. However, once the low impedance connection of fuse 1005 is disrupted, so that fuse 1005 becomes an open circuit, gate 1113 of FET 1115 will swing to supply voltage 1001 and FET 1115 will turn on and conduct between its source and its drain. As a consequence current will flow through LED 1115, causing it to illuminate.

What is claimed is:

1. A fuse, comprising:
an electrical circuit with a low impedance connection coupling together two connection points; and
a micro mechanical device operable to disrupt said low impedance connection and thereby cause an open circuit condition between said two connection points.

2. The invention as defined in claim 1 wherein said disruption directly causes said open circuit condition.

3. The invention as defined in claim 1 wherein movement of at least a part of said micro mechanical device disrupts said low impedance connection.

4. The invention as defined in claim 1 wherein movement of at least a part of said micro mechanical device disrupts said low impedance connection, and said micro mechanical device is adapted to perform said movement only when prescribed conditions are met.

5. The invention as defined in claim 1 wherein said micro mechanical device is a micro-electrical mechanical system (MEMS) device including at least one spring that is electrically part of said electrical circuit, and wherein said low impedance connection is disrupted by movement of said MEMS device such that said at least one spring is broken.

6. The invention as defined in claim 1 wherein disrupting of said low impedance connection is detected by said electrical circuit.

7. The invention as defined in claim 1 wherein said low impedance connection passes through a bridge that is disrupted by being broken by an impact with said micro mechanical device as a result of its motion.

8. The invention as defined in claim 1 wherein movement of at least a part of said micro mechanical device disrupts said low impedance connection, and wherein said micro mechanical device is latched into a new position after its movement.

9. The invention as defined in claim 1 wherein said bridge is a part of said micro mechanical device.

10. The invention as defined in claim 1 wherein said bridge is not a part of said micro mechanical device.

11. The invention as defined in claim 1 wherein a sequence of at least two movements of said micro mechanical device are required to disrupt said low impedance connection.

12. The invention as defined in claim 1 wherein said micro mechanical device has a plurality of movable parts, each of which must move in its own respective prescribed manner in order to disrupt said low impedance connection.

13. The invention as defined in claim 1 further comprising:
at least one electrode positioned so that a voltage between said electrode and said micro mechanical device causes said micro mechanical device to move; and
test ports for measuring capacitance between said at least one electrode and said micro mechanical device.

14. The invention as defined in claim 1 wherein said micro mechanical device must move in at least two directions to disrupt said electrical circuit.

15. The invention as defined in claim 14 wherein said directions are substantially opposite to each other with respect to a local coordinate system of said fuse.

16. A fuse, comprising:
low impedance electrical connection means coupling two connection points of a circuit to substantially the same potential; and
micro mechanical means for disrupting, under at least one prescribed condition, said low impedance electrical connection means so that said two connection points are completely uncoupled.

17. The invention as defined in claim 16 further comprising means for testing the integrity of said means for disrupting.

18. The invention as defined in claim 16 further comprising means for testing the motion ability of said micro mechanical means for disrupting.

19. The invention as defined in claim 16 further comprising means for latching said micro mechanical means after said at least one prescribed condition has been met.

20. The invention as defined in claim 16 wherein under said at least one prescribed condition said micro mechanical means for disrupting moves in a first direction.

21. The invention as defined in claim 16 wherein under said prescribed condition said micro mechanical means for disrupting moves initially in a first direction with respect to a local coordinate system of said fuse and subsequently in a second direction with respect to a local coordinate system of said fuse prior to said means for bypassing being disrupted.

22. The invention as defined in claim 16 wherein under said prescribed condition said micro mechanical means for disrupting moves in a first direction with respect to a local coordinate system of said fuse with at least a minimum prescribed acceleration.

23. The invention as defined in claim 16 further comprising means responsive to said two connection points becoming completely uncoupled.

24. The invention as defined in claim 16 wherein said micro mechanical means for disrupting includes a plurality of movable parts, each of which must move in its own respective prescribed manner in order to disrupt said low impedance electrical connection means so that said two connection points are completely uncoupled.

25. A method for use in a fuse, the method comprising the step of switching the two connection points from being connected to being open circuited by disrupting a low impedance connection between said two connection points as a result of the motion of a micro mechanical device.

26. The invention as defined in claim 25 further comprising the step of latching said micro mechanical device after completion of said switching step.

27. The invention as defined in claim 25 further wherein said switching step further comprises the step of breaking at least one bridge in a low impedance circuit connecting said two connecting points.

28. A method for use with a fuse including an electrical circuit with a low impedance connection coupling together two connection points and a micro mechanical device operable to disrupt said low impedance connection and thereby cause an open circuit condition between said two connection points the method comprising the step of testing the electrical integrity of said low impedance connection between said two connection points.

29. A method for use with a fuse including an electrical circuit with a low impedance connection coupling together two connection points and a micro mechanical device operable to disrupt said low impedance connection and thereby cause an open circuit condition between said two connection points, the method comprising the step of testing the ability of said micro mechanical device to move.
